(19) United States
(12) Patent Application Publication
(10) Pub. No.: US 2011/0133483 A1
(43) Pub. Date: Jun. 9, 2011

(54) WIND POWER GENERATOR

(75) Inventors: Jiro YONEDA, Tokyo (JP); Shinsuke SATO, Tokyo (JP); Takashi OKAFUJI, Tokyo (JP); Yoshiaki ITO, Tokyo (JP); Hiroyoshi KUBO, Tokyo (JP); Tomohiro BABA, Tokyo (JP)

(73) Assignee: MITSUBISHI HEAVY INDUSTRIES, LTD., Tokyo (JP)

(21) Appl. No.: 12/957,107

(22) Filed: Nov. 30, 2010

(30) Foreign Application Priority Data
Dec. 4, 2009 (JP) 2009-276349

(51) Int. Cl. F03D 11/00

(52) U.S. Cl. 290/1 B

(57) ABSTRACT

Provided is a wind power generator equipped with a circulating passage including a downward passage through which air in a nacelle flows downward from the nacelle through a tower and an upward passage through which the air that has flowed downward flows upward through the tower into the nacelle; and a heat exchanger part configured to exchange heat between the air and outside air at an intermediate portion of the circulating passage, wherein the upward passage is thermally insulated.

### TECHNICAL FIELD

The present invention relates to a wind power generator.

This application is based on Japanese Patent Application No. 2009-276349, the content of which is incorporated herein by reference.

### BACKGROUND ART

A known wind power generator generates electricity using wind power, which is natural energy. This type of wind power generator has wind turbine blades on a nacelle mounted on a tower and rotationally drives a generator mounted in the nacelle using the rotational force of the wind turbine blades to generate electricity. During the conversion, the temperature in the nacelle is increased due to energy loss, heat generated from a control unit that controls the operation, etc.

The heat generated in the nacelle is dissipated outside by cooling the interior of the nacelle directly or indirectly by drawing in outside air that is lower in temperature than that in the nacelle and discharging the drawn air to the outside of the nacelle. However, since outside air contains moisture and salt, direct introduction of the outside air into the nacelle may cause corrosion of the devices in the nacelle, thus posing a problem in terms of durability.

An example in which there is no need to introduce air from the outside to prevent environmental degradation in the nacelle is proposed in Patent Literature 1.

This is configured such that a double wall is provided in a tower that supports the nacelle to form a circulating passage in which air in the nacelle returns through the double wall of the tower, thereby exchanging heat between the air in the nacelle and air (wind) flowing outside the tower.

### CITATION LIST

### Patent Literature

{PTL 1} Japanese Translation of PCT International Application, Publication No. 2003-504562

### SUMMARY OF INVENTION

### Technical Problem

In the example shown in Patent Literature 1, since an area for heat exchange is provided over substantially the whole side surface of the tower, there is a possibility that air serving as a coolant is cooled in the tower and is thereafter warmed by outside air before returning to the nacelle, which requires enhancement of the cooling efficiency.

Furthermore, since the circulating passage is formed at a substantially uniform length (depth) in a flowing direction and is long in the flowing direction, the air flowing therethrough becomes a laminar flow, which requires enhancement of the heat exchange efficiency.

In view of such a situation, an object of the present invention is to provide a wind power generator capable of efficiently cooling the devices in the nacelle by suppressing reheating of the cooled air to enhance the cooling efficiency.

### Solution to Problem

The present invention adopts the following solutions to solve the problems described above.

That is, one aspect of the present invention is a wind power generator including a circulating passage including a downward passage through which air in a nacelle flows downward from the nacelle through a tower portion and an upward passage through which the air that has flowed downward flows upward through the tower portion into the nacelle; and a heat exchanger part configured to exchange heat between the air and outside fluid at an intermediate portion of the circulating passage, wherein the upward passage is thermally insulated.

With the wind power generator according to this aspect, the air in the nacelle flows downward through the downward passage, and the air that has flowed down flows upward through the upward passage and returns to the nacelle. At that time, the air that passes through the circulating passage is cooled by exchanging heat with that of relatively low-temperature outside fluid via the heat exchanger part.

At this time, since the upward passage of the circulating passage is thermally insulated, the air that has already been cooled can be prevented from being heated when passing through the upward passage under any conditions.

This can enhance the cooling efficiency of the air in the nacelle. Accordingly, since the devices in the nacelle can be sufficiently cooled by the cooled air that returns into the nacelle through the upward passage without introducing outside air into the nacelle, the corrosion resistance in the nacelle can be enhanced.

In the above aspect, preferably, the upward passage is disposed away from the wall of the tower portion.

This can prevent the inside air that has already been cooled from being heated by heat input from the wall when flowing upward through the upward passage.

With the above configuration, the downward passage may be disposed so as to surround the outer periphery of the upward passage, and the wall of the tower portion may be used as an outer-periphery-side passage wall.

Since the downward passage is disposed so as to surround the outer periphery of the upward passage, and the wall of the tower portion is used as an outer-periphery-side passage wall, as described above, the downward passage can form a heat exchanger part around the whole circumference of the tower portion. This allows the heat exchanger part to perform heat exchange irrespective of the direction of the wind.

With the above configuration, the downward passage and the upward passage may constitute part of a cross section of the tower portion.

Since this allows another member to be disposed in the tower portion, the space in the tower portion can be used effectively.

For example, this is particularly advantageous when applied to a wind power generator installed at, for example, a place where the wind direction does not change much.

In the above aspect, the circulating passage may be fitted with a thermal insulator at least part, except where the heat exchanger part is provided.

In the above aspect, preferably, the heat exchanger part includes, upstream of the heat exchanger part, a turbulent-flow forming member that makes the flow of air passing therethrough turbulent.

Since the heat exchanger part includes, upstream of the heat exchanger part, the turbulent-flow forming member that makes the flow of air passing therethrough turbulent, the flow of air flowing upstream of the heat exchanger part is made turbulent, in other words, becomes a turbulent flow, by the turbulent-flow forming member. Thus, air that is not cooled is replaced in the channel and is cooled by the outside fluid by heat exchange, thus enhancing the heat exchange efficiency of the heat exchanger part.

With the above configuration, the turbulent-flow forming member may be formed so as to decrease in cross sectional area from the outer-periphery-side passage wall to the inside.

This can increase the area of the channel of the upward passage side portion, that is, the inside portion, of the downward passage, which participates relatively little in heat exchange, thereby further decreasing the air pressure loss.

### ADVANTAGEOUS EFFECTS OF INVENTION

According to the present invention, since the upward passage is thermally insulated, the cooling efficiency of air in the nacelle can be enhanced under any conditions.

### BRIEF DESCRIPTION OF DRAWINGS

FIG. 1 is a longitudinal sectional view illustrating the schematic configuration of a wind power generator according to a first embodiment of the present invention.

FIG. 2 is a cross-sectional view taken along line X-X in FIG. 1.

FIG. 3 is a cross-sectional view taken along line Y-Y in FIG. 1.

FIG. 4 is a cross-sectional view illustrating another embodiment of a turbulent-flow forming member according to the first embodiment of the present invention, which illustrates the same part as in FIG. 2.

FIG. 5 is a cross-sectional view illustrating yet another embodiment of the turbulent-flow forming member according to the first embodiment of the present invention, which illustrates the same part as in FIG. 2.

FIG. 6 is a cross-sectional view of a first modification of a circulating passage according to the first embodiment, which illustrates the same part as in FIG. 2.

FIG. 7 is a cross-sectional view of the first modification of the circulating passage according to the first embodiment, which illustrates the same part as in FIG. 3.

FIG. 8 is a cross-sectional view of another modification of the circulating passage according to the first modification, which illustrates the same part as in FIG. 2.

FIG. 9 is a cross-sectional view of a second modification of the circulating passage according to the first embodiment, which illustrates the same part as in FIG. 2.

FIG. 10 is across-sectional view of the second modification of the circulating passage according to the first embodiment, which illustrates the same part as in FIG. 3.

FIG. 11 is a cross-sectional view of another modification of the circulating passage according to the second modification, which illustrates the same part as in FIG. 2.

FIG. 12 is a longitudinal sectional view illustrating the schematic configuration of a wind power generator according to a second embodiment.

### DESCRIPTION OF EMBODIMENTS

Embodiments of the present invention will be described in detail below using the attached drawings.

### First Embodiment

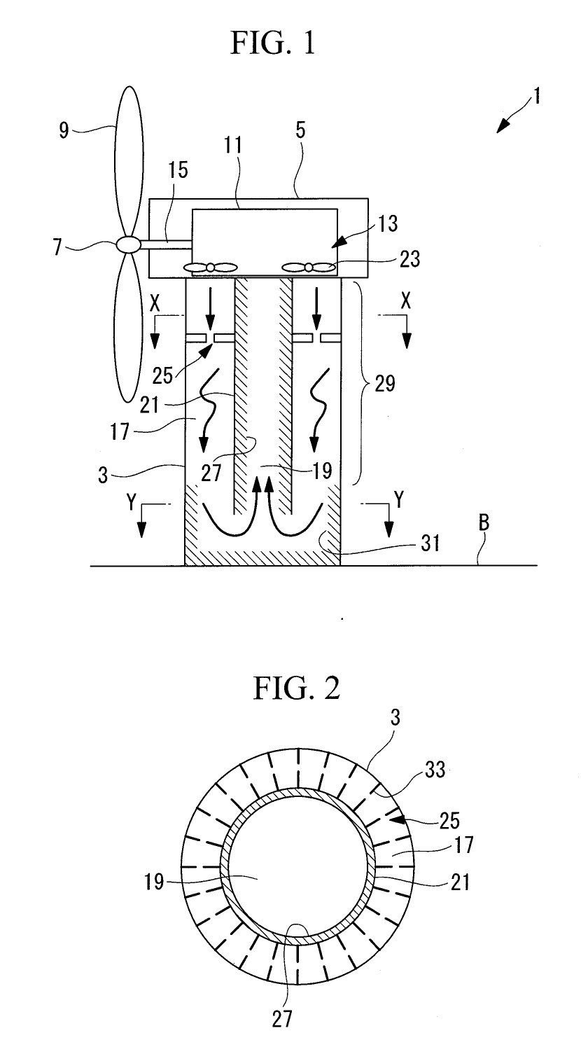

A terrestrial wind power generator 1 according to a first embodiment of the present invention will be described below with reference to FIGS. 1 to 3.

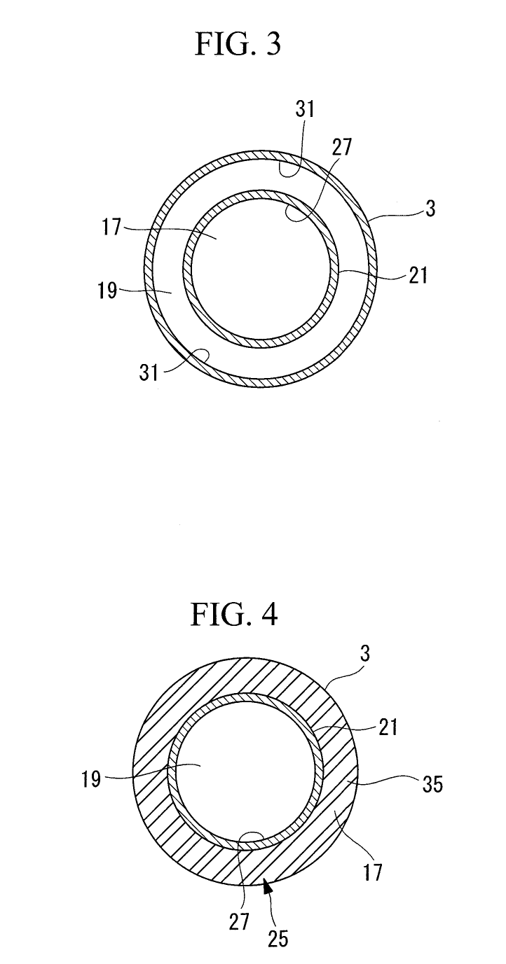

FIG. 1 is a longitudinal sectional view illustrating the schematic configuration of the wind power generator 1 according to the first embodiment. FIG. 2 is a cross-sectional view taken along line X-X in FIG. 1. FIG. 3 is a cross-sectional view taken along line Y-Y in FIG. 1.

The wind power generator 1 is provided with a tower (tower portion) 3 that is vertically erected on a base B, a nacelle 5 mounted on the upper end of the tower 3, a rotor head 7 mounted on the nacelle 5 so as to be rotatable about the substantially horizontal rotation axis thereof, a plurality of wind turbine blades 9 mounted in a radiating pattern on the rotor head 7, generator equipment 11 that generates electricity by the rotation of the rotor head 7, and cooling equipment 13.

The tower 3 is a column made of metal, concrete, or a metal-concrete composite and having a hollow, cylindrical shape extending upward (upward in FIG. 1) from the base B, as shown in FIG. 1.

The nacelle 5 is provided at the uppermost portion of the tower 3 so as to be rotatable about the axial center of the tower 3.

As shown in FIG. 1, the nacelle 3 rotatably supports a main shaft 15 fixed to the rotor head 7.

The generator equipment 11 is provided with, for example, a gearbox joined to the main shaft 15, a generator that is rotationally driven by the gearbox, a rectifier that rectifies electricity generated by the generator, a transformer that changes the voltage, a control unit that controls the operation of the wind power generator including these devices, etc.

The internal temperature of the nacelle 5 is increased due to heat generated from bearings, the gearbox, the generator, an inverter, etc.

The cooling equipment 13 is for cooling air in the nacelle 5.

The cooling equipment 13 is equipped with a partitioning portion 21 that forms a downward passage 17 and an upward passage 19, a plurality of fans 23 that supply the air in the nacelle 5 to the downward passage 17, and a turbulent-flow forming member 25 mounted at an intermediate portion of the downward passage 17.

The partitioning portion 21 has a hollow, cylindrical shape and is mounted so as to have substantially the same axial center as the tower 3 and to extend from the lower portion of the nacelle 5 to the vicinity of the lower portion of the tower 3.

The partitioning portion 21 forms the downward passage 17, which is a space with a hollow, cylindrical shape, between the outer peripheral wall thereof and the outer peripheral wall of the tower 3 and forms the cylindrical upward passage 19 along the inner periphery thereof.

Accordingly, the downward passage 17 is disposed so as to surround the outer periphery of the upward passage 19.

The plurality of fans 23 are disposed circumferentially at certain intervals in the nacelle 5 so as to face the opening of the downward passage 17.

The fans 23 supply the air in the nacelle 5 to the downward passage 17. The supplied air flows downward through the downward passage 17 and flows into the upward passage 19 in substantially the vicinity of the lower end of the tower 3. The air that has flowed into the upward passage 19 is returned to the nacelle 5 through the upward passage 19.

The downward passage 17 and the upward passage 19 constitute a circulating passage of the present invention.

A thermal insulating layer 27 to which a thermal insulator is attached over substantially the whole surface thereof is formed along the inner peripheral surface of the partitioning portion 21.

Outside air (fluid) generally decreases in temperature as it rises from the base B to the upper region, that is, to a higher region. To use it, a portion extending from the nacelle 5 to substantially 70% of the height of the downward passage 17 serves as a heat exchanger part 29.

A thermal insulating layer 31 to which a thermal insulator is attached is formed on the inner peripheral surface of the tower 3 in a region except where the heat exchanger part 29 is provided. Accordingly, the thermal insulating layers 27 and 31 are formed, in other words, thermal insulators are attached, in a region of the circulating passage except where the heat exchanger part 29 is provided.

An example of the thermal insulators of the thermal insulating layers 27 and 31 is urethane. The thermal insulators are not limited thereto; styrene foam or the like can be used as appropriate.

The turbulent-flow forming member 25 is mounted at a position of substantially one third of the heightwise length of the heat exchanger part 29 from the nacelle 5, that is, at an upstream portion of the heat exchanger part 29.

As shown in FIG. 2, the turbulent-flow forming member 25 is formed of a large number of pins 33 provided circumferentially at certain intervals. The pins 33 are provided so as to project substantially horizontally from the inner peripheral surface (outer-periphery-side passage wall) of the tower 3 and from the outer peripheral surface of the partitioning portion 21 toward the downward passage 17 so as to face each other.

The turbulent-flow forming member 25 is an obstacle to the flow of air flowing through the downward passage 17, which makes the airflow turbulent, and is not limited to the pins 33 but may have various kinds of structure.

For example, as shown in FIG. 4, the turbulent-flow forming member 25 may be rods 35 that are arranged at certain intervals substantially in parallel on the surface of the downward passage 17.

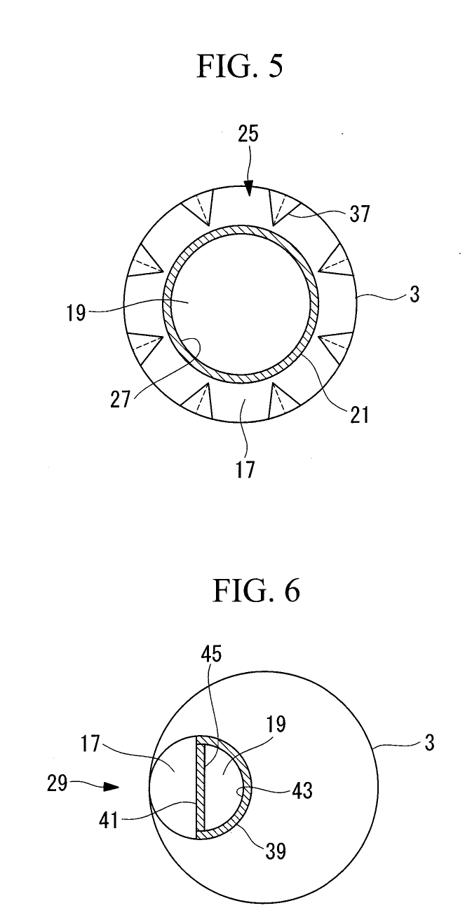

Alternatively, as shown in FIG. 5, the turbulent-flow forming member 25 may be constituted by a plurality of protruding portions 37 mounted on the inner peripheral surface of the tower 3.

The protruding portions 37 have a substantially triangular pyramid shape and are mounted such that one side extends substantially horizontally. The protruding portions 37 are formed such that the cross-sectional area decreases from the inner peripheral surface of the tower 3 toward the inside, and the apex is spaced from the partitioning portion 21.

This can increase the area of the air channel of the upward passage 19 side portion, that is, the inside portion, of the downward passage 17, which participates relatively little in heat exchange, thereby further decreasing the pressure loss of the air flowing through the downward passage 17.

The protruding portions 37 are not limited to the triangular pyramid but may be any pyramid, such as a polygonal pyramid and a cone, or any frustum, such as a triangular frustum. The protruding portions 37 may have any desired shape provided that they are shaped so that the cross-sectional areas decrease from the inner peripheral surface of the tower 3 to the inside.

The operation of the thus-configured wind power generator 1 according to this embodiment will be described.

The force of wind that blows against the wind turbine blades 9 from the direction of the rotation axis of the rotor head 7 is converted to a motive power causing the wind turbine blades 9 to move, thereby rotating the rotor head 7 about the rotation axis.

The rotation of the rotor head 7 is transmitted through the main shaft 15 to the generator equipment 11. The generator equipment 11 generates electricity using the transmitted rotational power.

Here, the rotor head 7 is directed windward at least during the power generation by appropriately rotating the nacelle 5 on a horizontal plane to effectively make the power of the wind act on the wind turbine blades 9.

At this time, since the internal temperature of the nacelle 5 is increased due to the heat generation of the gearbox, the generator, the inverter, etc., the interior of the nacelle 5 is cooled by the cooling equipment 13.

In the cooling equipment 13, the fans 23 are operated. When the fans 23 are operated, the air in the nacelle 5 is fed to the downward passage 17 and flows downward through the downward passage 17.

Outside air generally decreases in temperature as it rises from the base B to the upper region. The upper portion of the outer peripheral surface of the tower 3 is cooled by this relatively low-temperature outside air.

In the heat exchanger part 29, since the tower 3 constitutes the outer-periphery-side passage wall of the downward passage 17, heat is discharged from the air passing through the heat exchanger part 29 of the downward passage 17 to the outside air via the tower 3.

Since the downward passage 17, that is, the heat exchanger part 29, is formed around the whole circumference of the tower 3, the heat exchanger part 29 can perform heat exchange irrespective of the direction of the wind.

The air flowing through the downward passage 17 is rectified into a laminar flow with an increasing distance from the fans 23. When this air reaches the installation position of the turbulent-flow forming member 25, the flow is disturbed by the pins 33, becoming a turbulent flow.

Thus, air that is in contact with the tower 3 is replaced, in other words, air that is not cooled by heat exchange is replaced in sequence and contacts the tower 3, and thus increasing the difference in temperature of the medium used for heat exchange. This can therefore enhance the heat exchange efficiency of the heat exchanger part 29.

The turbulent-flow forming member 25 can also be omitted.

The air cooled by the heat exchanger part 29 flows into the upward passage 19 in the vicinity of the substantially lower end of the tower 3. The air that has flowed into the upward passage 19 is returned to the nacelle 5 through the upward passage 19 to cool the devices in the nacelle 5.

At this time, since the thermal insulating layer 31 is provided at the portion of the downward passage 17 except where the heat exchanger part 29 is provided, and the thermal insulating layer 27 is provided over the whole surface of the upward passage 19, the air that has already been cooled can be prevented from being heated under any conditions.

This can enhance the cooling efficiency of the air in the nacelle 5.

Accordingly, since the devices in the nacelle 5 can be sufficiently cooled without introducing outside air into the nacelle 5, the corrosion resistance in the nacelle 5 can be enhanced.

Although this embodiment is configured to use the whole inner space of the tower 3 as the downward passage 17 and the upward passage 19, part thereof may be used as in a first modification and a second modification, described below.

Although the fans 23 are disposed in the nacelle 5, they may be disposed separately or additionally in an appropriate position in the circulating passage.

Furthermore, the thermal insulating layer 27 attached to the partitioning portion 21 is attached to the inner peripheral surface of the partitioning portion 21; the same advantages can be provided even if it is attached to the outer peripheral surface.

Furthermore, although this embodiment is configured such that the circulating passage extends to the vicinity of the lower portion of the tower 3, the circulating passage may be extended to an upper portion or an intermediate portion of the tower 3 in accordance with a required cooling capacity because outside air decreases in temperature as it moves upward, as described above.

### First Modification

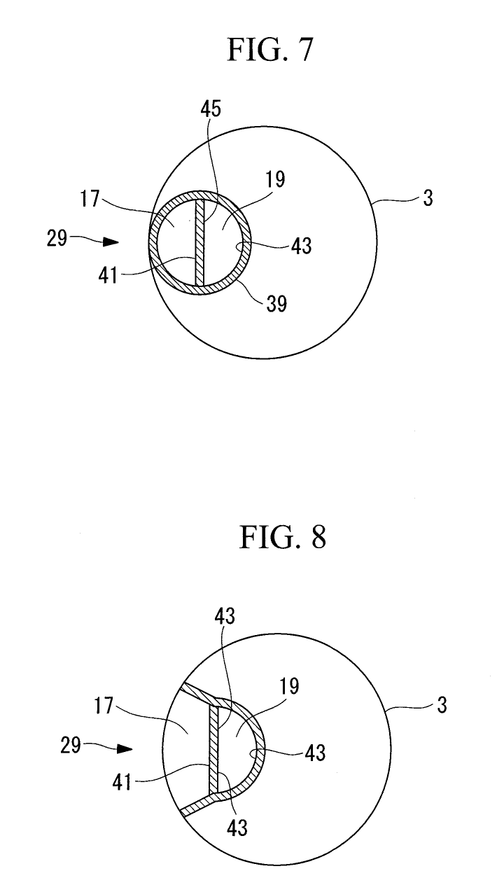

The wind power generator 1 according to a first modification will be described using FIGS. 6 and 7. FIG. 6 is a cross-sectional view of the upper portion of the tower 3, as in FIG. 2 of the first embodiment. FIG. 7 is a cross-sectional view of the lower portion of the tower 3, as in FIG. 3 of the first embodiment.

Since this modification differs from the first embodiment in the configuration of the downward passage 17 and the upward passage 19, the difference will be mainly described here.

In this modification, a hollow, substantially cylindrical tube 39 is disposed in contact with the tower 3, with its axial center being substantially parallel to the axial center of the tower 3. The tube 39 is mounted so as to extend vertically such that the open upper surface faces the nacelle 5 and the closed lower surface is in the vicinity of the lower end of the tower 3. The diameter of the tube 39 is set to substantially 45% of the diameter of the tower 3.

The tube 39 is partitioned in cross section substantially into halves by a partition plate 41 to form the downward passage 17 located at the outer periphery side of the tower 3 and the upward passage 19 located inside.

The downward passage 17 and the upward passage 19 are communicated with each other at the lower portion of the tube 39.

The heat exchanger part 29 is formed, in substantially the same range as in the first embodiment, at the upper portion of the downward passage 17. A thermal insulating layer 43 to which a thermal insulator is attached is formed on the inner peripheral surface of the tube 39 in a region of the downward passage 17 except where the heat exchanger part 29 is provided.

A thermal insulating layer 45 to which a thermal insulator is attached over substantially the whole surface of the partition plate 41 is formed at the upward passage 19 side thereof.

The turbulent-flow forming member 25 described above may be attached at the heat exchanger part 29 portion of the downward passage 17.

Furthermore, the downward passage 17 of the heat exchanger part 29 may have a sector form in cross section, as shown in FIG. 8. Since this can increase the region in which the downward passage 17 is in contact with the tower 3, the heat exchange efficiency can be enhanced.

Since the operation of the thus-configured wind power generator 1 according to this modification is basically the same as that of the first embodiment, duplicated descriptions will be omitted.

In this comparative example, since the tube 39 in which the downward passage 17 and the upward passage 19 are formed merely constitutes part of a cross section of the tower 3, the remaining space can be used effectively for another purpose.

In this comparative example, since the heat exchanger part 29 is limited to part in the circumferential direction of the tower 3, the heat exchange efficiency changes depending on the wind direction. Therefore, this is particularly advantageous when applied to the wind power generator 1 installed at, for example, a place where the wind direction does not change much.

### Second Modification

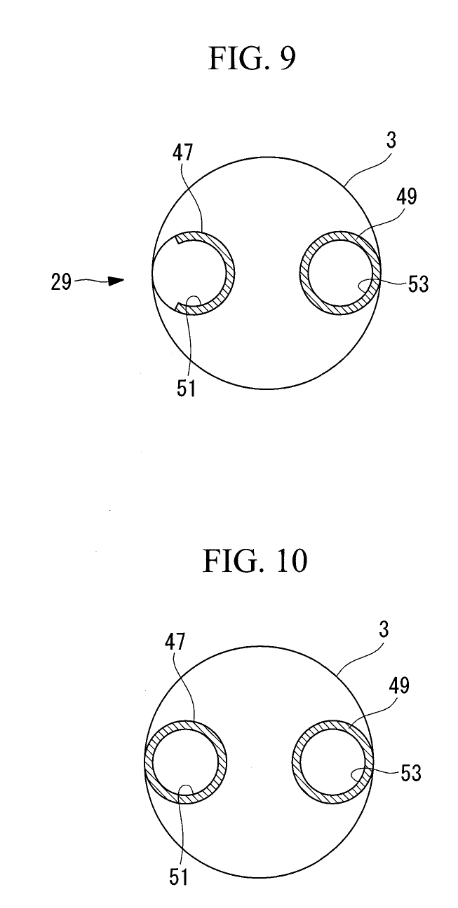

The wind power generator 1 according to a second modification will be described using FIGS. 9 and 10. FIG. 9 is a cross-sectional view of the upper portion of the tower 3, as in FIG. 2 of the first embodiment. FIG. 10 is a cross-sectional view of the lower portion of the tower 3, as in FIG. 3 of the first embodiment.

Since this modification differs from the first embodiment in the configuration of the downward passage 17 and the upward passage 19, the difference will be mainly described here.

In this modification, a pair of hollow, substantially cylindrical tubes 47 and 49 are disposed at substantially symmetric positions about the axial center of the tower 3 in such a manner that the axial centers of the tubes 47 and 49 are substantially parallel to the axial center of the tower 3 and the tube 47 is in contact with the tower 3.

The tubes 47 and 49 are mounted so as to extend vertically in such a manner that the individual open upper surfaces face the nacelle 5 and the open lower surfaces are close to the lower end of the tower 3. The diameters of the tubes 47 and 49 are set to substantially 30% of the diameter of the tower 3.

The tube 47 constitutes the downward passage 17 and is provided with a fan 23 that faces the upper surface thereof for feeding air.

The heat exchanger part 29 is formed in a region substantially as high as that of the first embodiment at an upper position of the downward passage 17 at the side at which the heat exchanger part 29 is in contact with the tower 3.

A thermal insulating layer 51 to which a thermal insulator is attached is formed on the inner peripheral surface of the tube 47 in a region except where the heat exchanger part 29 at the tower 3 side is provided.

The tube 49 constitutes the upward passage 19 and is provided with a fan 23 that faces the upper surface thereof for sucking air.

A thermal insulating layer 53 to which a thermal insulator is attached is formed over substantially the whole surface of the inner peripheral surface of the tube 47.

The turbulent-flow forming member 25 described above may be mounted to the portion of the heat exchanger part 29 of the downward passage 17.

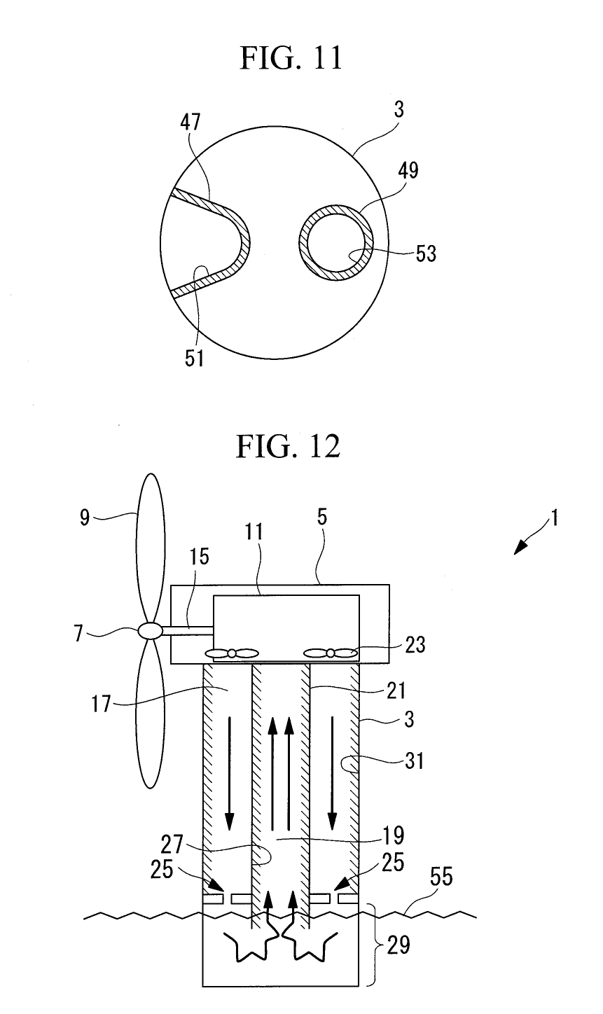

Furthermore, the downward passage 17 of the heat exchanger part 29 may have a sector form in cross section, as shown in FIG. 11. Since this can increase the range in which the downward passage 17 is in contact with the tower 3, the heat exchange efficiency can be enhanced.

The operation of the thus-configured wind power generator 1 according to this modification will be described.

In this comparative example, the air in the nacelle 5 is introduced into the downward passage 17 with the fan 23 and is blown out to the lower end of the tower 3. On the other hand, since the other fan 23 sucks air into the nacelle 5 at the upper end of the upward passage 19, the air blown out of the downward passage 17 is sucked into the lower end of the upward passage 19 and is fed to the nacelle 5.

Since the other operations are basically the same as those of the first embodiment, duplicated descriptions will be omitted.

Since the tubes 47 and 49 in which the downward passage 17 and the upward passage 19 are formed, respectively, merely constitute part of a cross section of the tower 3, the remaining space can be used effectively for another purpose.

In this comparative example, since the heat exchanger part 29 is limited to part in the circumferential direction of the tower 3, the heat exchange efficiency changes depending on the wind direction. Therefore, it is particularly advantageous to apply the comparative example to the wind power generator 1 installed at, for example, a place where the wind direction does not change much.

Furthermore, the lower ends of the tubes 47 and 49 may be connected to each other to communicate between the downward passage 17 and the upward passage 19.

This can assuredly introduce the air cooled by the heat exchanger part 29 of the downward passage 17 into the upward passage 19, and the fan 23 provided at the upward passage 19 can be omitted.

### Second Embodiment

Next, a wind power generator 1 according to a second embodiment of the present invention will be described using FIG. 12. The wind power generator 1 according to this embodiment is installed on the sea.

Since this embodiment differs from the first embodiment in the position of the heat exchanger part 29, the difference will be mainly described, and duplicated descriptions of parts that are the same as those of the foregoing first embodiment will be omitted here.

The same components as those of the first embodiment are given the same reference numerals.

FIG. 12 is a longitudinal sectional view illustrating the schematic configuration of the wind power generator 1 according to this embodiment.

The wind power generator 1 installed on the sea floats in a desired sea area due to the buoyancy of the tower 3 etc. Therefore, the lower portion of the tower 3 is located below a sea surface 55.

Since seawater is generally lower in temperature than air, the heat exchanger part 29 is formed at the lower portion of the tower 3, which is deeper than the sea surface 55.

The turbulent-flow forming member 25 is disposed at the inlet of the heat exchanger part 29, that is, upstream of the heat exchanger part 29.

Since the operation of the thus-configured wind power generator 1 according to this embodiment is basically the same as that of the first embodiment, duplicated descriptions will be omitted.

With the wind power generator 1 of the type in which the nacelle 5 is fixed to the tower 3, the tower 3 rotates on its axis depending on the wind direction, so that the wind blows against a fixed position in the circumferential direction of the tower 3. In this case, effective cooling can be performed also with the first modification and the second modification described above.

The present invention is not limited to the above embodiments; various modifications may be made without departing from the spirit of the present invention.

### REFERENCE SIGNS LIST

1 wind power generator
3 tower
5 nacelle
17 downward passage
19 upward passage
25 turbulent-flow forming member
27, 31, 41, 43, 51, 53 thermal insulating layer

1. A wind power generator comprising:
a circulating passage including a downward passage through which air in a nacelle flows downward from the nacelle through a tower portion and an upward passage through which the air that has flowed downward flows upward through the tower portion into the nacelle; and
a heat exchanger part configured to exchange heat between the air and outside fluid at an intermediate portion of the circulating passage,
wherein the upward passage is thermally insulated.

2. The wind power generator according to claim 1, wherein the upward passage is disposed away from the wall of the tower portion.

3. The wind power generator according to claim 2, wherein the downward passage is disposed so as to surround the outer periphery of the upward passage, and the wall of the tower portion is used as an outer-periphery-side passage wall.

4. The wind power generator according to claim 2, wherein the downward passage and the upward passage occupy only part of a cross section of the tower portion.

5. The wind power generator according to claim 1, wherein the circulating passage is fitted with a thermal insulator at at least part, except where the heat exchanger part is provided.

6. The wind power generator according to claim 1, wherein the heat exchanger part includes, upstream of the heat exchanger part, a turbulent-flow forming member that makes the flow of air passing therethrough turbulent.

7. The wind power generator according to claim 6, wherein the turbulent-flow forming member is formed so as to decrease in cross sectional area from the outer-periphery-side passage wall to the inside.
